(19) United States
(12) Patent Application Publication
(10) Pub. No.: US 2024/0394649 A1
(43) Pub. Date: Nov. 28, 2024

(54) SYSTEM AND METHOD FOR PROVIDING EXPEDITED SHIPPING

(71) Applicant: Kevin Kaufman, Lafayette, IN (US)

(72) Inventor: Kevin Kaufman, Lafayette, IN (US)

(21) Appl. No.: 18/322,650

(22) Filed: May 24, 2023

(51) Int. Cl. G06Q 10/0835

(52) U.S. Cl. CPC G06Q 10/08355

(57) ABSTRACT

A method of providing expedited shipping includes receiving a request for a shipment to be delivered to a receiving location and locating the shipment at a shipping location. The method also includes identifying a qualifying route from different predetermined freight delivery routes, wherein the qualifying route passes within a predetermined proximity of each of the shipping location and the receiving location. The freight carrier deviates from the qualifying route to pickup the shipment at the shipping location and deliver the shipment to the receiving location.

### TECHNICAL FIELD

The present disclosure relates to the field of shipping. More specifically, the present disclosure is directed to a system and method for providing expedited shipping.

### BACKGROUND

On-demand delivery services, such as DoorDash® and Uber®, are becoming more and more commonplace. Many of these service providers offer on-demand transportation that can satisfy real-time demands quickly and efficiently. However, these expedited services come at an increased cost. As such, there is a growing need for alternative options for expedited shipping that is more widely available and is not cost-prohibitive.

The present technology is directed to and addresses the issues identified above.

### SUMMARY

The present disclosure relates to a system and method for providing expedited shipping.

According to one aspect of the present disclosure, a method of providing expedited shipping includes first receiving a request for a shipment, which may include one or more items, to be delivered to a receiving location and then locating the shipment at a shipping location. The method also includes providing a list of participating freight carrier operators operating freight carriers, such as freight trucks, along a plurality of different predetermined freight delivery routes. The method also includes identifying a qualifying route from the plurality of different predetermined freight delivery routes using an app running on a smart device, wherein the qualifying route passes within a predetermined proximity of each of the shipping location and the receiving location. The qualifying route is confirmed using criteria applied using the app. After all the parties are satisfied with the agreement, the freight carrier deviates from the qualifying route, which corresponds to the already scheduled predetermined route, to pick up the shipment at the shipping location and deliver the shipment to the receiving location. The shipment is transported in a designated container supported by the freight carrier assigned to the qualifying route.

According to another aspect of the present disclosure, a system for providing expedited shipping includes an infrastructure for an app, including, for example, a web app or a mobile app, installed on a smart device communicating with a backend server and a database, as described below. The parties described herein are participants of the app. The app facilitates performance of the method described above, which includes receiving a request for a shipment to be delivered to a receiving location and locating the shipment at a shipping location. The app provides a list of participating freight carrier operators operating freight carriers along a plurality of different predetermined freight delivery routes, wherein the app identifies a qualifying route from the plurality of different predetermined freight delivery routes, wherein the qualifying route passes within a predetermined proximity of each of the shipping location and the receiving location. The app confirms the qualifying route based on predetermined criteria and the freight carrier assigned to the qualifying route deviates from the qualifying route to pick-up the shipment at the shipping location and deliver the shipment to the receiving location. The shipment is transported in a designed container supported by the freight carrier assigned to the qualifying route.

In yet another aspect of the present disclosure, a non-transitory computer-readable medium stores instructions that, when executed by a computer, cause it to preform a method. The method, which is again described above, includes providing expedited shipping includes receiving a request for a shipment to be delivered to a receiving location and locating the shipment at a shipping location. The method also includes providing a list of participating freight carrier operators operating freight carriers along a plurality of different predetermined freight delivery routes. The method also includes identifying a qualifying route from the plurality of different predetermined freight delivery routes using an app running on a smart device, wherein the qualifying route passes within a predetermined proximity of each of the shipping location and the receiving location. The qualifying route is confirmed using criteria applied using the app. The freight carrier deviates from the qualifying route to pick-up the shipment at the shipping location and deliver the shipment to the receiving location. The shipment is transported in a designated container supported by the freight carrier assigned to the qualifying route.

### BRIEF DESCRIPTION OF THE DRAWINGS

FIG. 1 depicts a simplified diagram of an architecture for an exemplary app, according to the present disclosure;

FIG. 2 depicts an exemplary graphical user interface of a smart device operating the exemplary app, according to the present disclosure;

FIG. 3 depicts an exemplary map showing a plurality of different freight carrier routes of a plurality of different freight carrier operators, according to the present disclosure;

FIG. 4 depicts an exemplary map showing a shipping location, a receiving location, and a qualifying route, according to the present disclosure;

FIG. 5 depicts an exemplary map showing a freight carrier deviating from the qualifying route to pick-up the shipment at the shipping location and deliver the shipment to the receiving location; and

FIG. 6 depicts a perspective view of a freight carrier having a designated container for supporting a shipment.

Like reference numbers and designations in the various drawings indicate like element.

### DETAILED DESCRIPTION

Before the present methods, implementations, and systems are disclosed and described, it is to be understood that this disclosure is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a, “an” and “the” include plural references unless the context clearly dictates otherwise. Ranges may be expressed in ways including from “about” one particular value, and/or to “about” another particular value. When such a range is expressed, another implementation may include from the one particular value. Another implementation may include from the one particular value and/or the other particular value. Similarly, when values are expressed as approximations, for example by use of the antecedent “about,” it will be understood that the particular value forms another implementation. It will be further understood that the description includes instances where said event or circumstance occurs and instances where it does not.

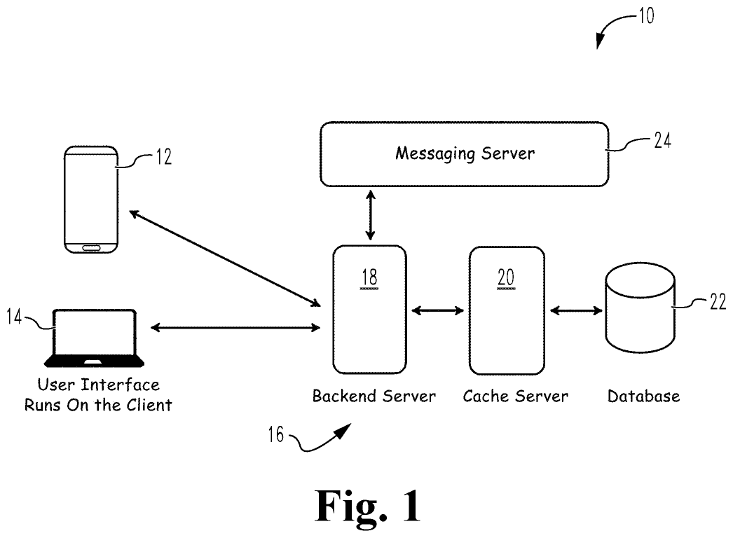

FIG. 1 depicts a simplified diagram 10 of an architecture for an exemplary app, according to the present disclosure. A mobile application or app is a computer program or software application designed to run on a smart device 12, also referenced as a mobile device, such as a phone, tablet or watch. Mobile applications often stand in contrast to desktop applications which are designed to run on desktop computers, and web applications which run in mobile web browsers rather than directly on the mobile device. However, apps can be created for both desktop 14 and mobile applications.

The back-end 16 of the app includes code that runs on a server 18, that receives requests from the clients, and contains the logic to send the appropriate data back to the client. The application server 18 works by managing the business logic of the mobile app, or application. The back-end 16 also includes non-transitory computer-readable medium storing instructions that, when executed by a computer, cause it to perform the method of the present disclosure. The medium is capable of storing data in a format easily readable by a digital computer or mechanical device (rather than human readable).

According to an exemplary embodiment, cached data, of a cache server 20, are files, scripts, images, and other multimedia stored on your device after opening an app or visiting a website for the first time. This data is then used to quickly gather information about the app or website every time revisited, reducing load time. The cached data may be stored in a database 22, which will persistently store all of the data for the application and manage all app data transactions.

A messaging server 24 is an application that handles messages between two or more applications. These messages are passed to the middleware application using a messaging API (MAPI). Messaging servers 24 are able to store messages in a queue until they can be delivered to the recipients applications.

Various other elements work together with, or as an alternative to, the elements described above to form a robust backend architecture, including, for example, load balancing technology, other object storage services, content delivery networks, application programming interfaces (APIs), application publishing platforms, etc.

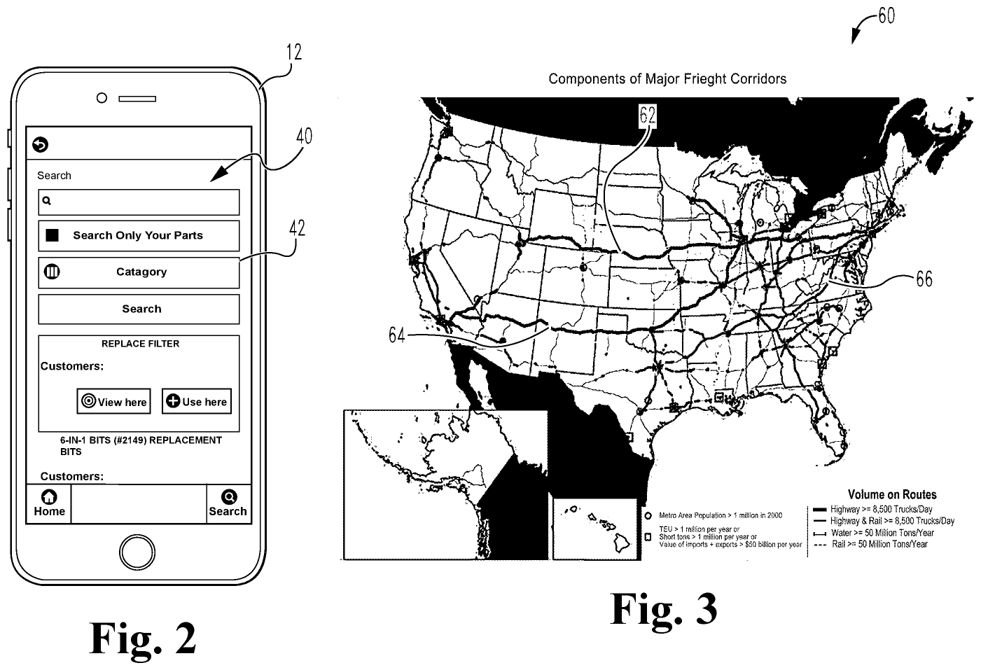

As shown in FIG. 2, a graphical user interface (GUI) 40, displayed on a screen 42 of the smart device 12, is a common user interface that includes graphical representation like buttons and icons, and communication can be performed by interacting with these icons rather than the usual text-based or command-based communication. The GUI 40 of the present disclosure may take a variety of different forms, but should be configured to perform, or facilitate performance of, the method steps described herein.

Apps are typically available via one or more app distribution platforms and have become more commonplace regarding creation, installation, and use. Participants in, or users of, the app of the present disclosure may include at least receivers, shippers, and freight carrier operators (including drivers). An exemplary use case of the presently disclosed system and method is described below.

A receiver, or user, identifies an urgent need for one or more items, also referenced as a shipment, to be delivered to a receiving location. By way of example only, the receiver may need a part, such as a machine part, for business or personal use, on an urgent basis. Using the GUI 40 of the app, the receiver may search and locate the part, or shipment, at one or more shipping locations. After the part, or shipment, is located, via the app, one or more possible pickup locations are identified, such as by the identified shipper. Additionally, the receiver may enter one or more possible delivery locations. All of these actions are facilitated using the app.

The app may include, store, or have access to a list of participating freight carrier operators, which may include drivers, or operators, which may include dispatchers, for example, operating freight delivery routes. Over time, numerous different freight carrier operators may participate, making the system and method more robust.

FIG. 3 depicts an exemplary map 60 showing a plurality of different freight carrier routes of a plurality of different freight carrier operators, such as routes 62, 64, and 66, operating across the United States, according to the present disclosure. The map 60 is shown only as an example, as it is likely that that the app will utilize, or have access to, a significantly larger number of freight delivery routes.

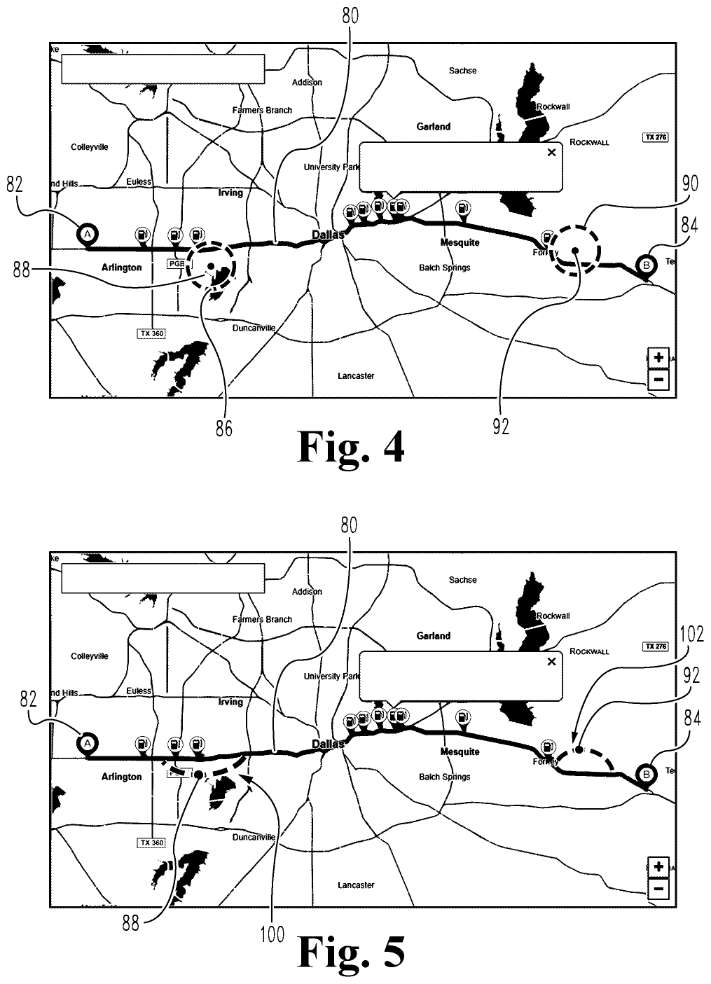

Turning now to FIG. 4, the app then identifies participating truck(s) (or their dispatchers) whose location is monitored by the app and who, as a matter of standard practice, have logged the intended route of the truck into the app. For example, an exemplary route 80 having a starting location 82 and a destination 84 is shown.

Having first identified participating and available trucks whose current, predetermined, intended route will take them within a predetermined proximity 86, such as, for example, 5 miles, of a proposed shipping location 88 and a predetermined proximity 90, such as, for example, 5 miles, of a proposed receiving location 92, the app will calculate the cost to the truck, in time and marginal expense, of making detours from their originally intended route to both retrieve and deliver the shipment. It should be noted that the predetermined proximities 86 and 90 are provided as examples only and may be modified using the app. Further, one or more shipping locations and/or receiving locations may be provided as alternatives to improve or better accommodate the process. In some cases, predetermined locations in the area have already been identified.

The app is also configured to present the participants with the weight of the item(s) so the freight carrier can determine whether the addition of the shipment would put the weight over an acceptable limit and whether all of the parties can physically handle the item. It should also be determined whether or not the designated container that the freight carrier will use to transport the shipment can accommodate the one or more items.

The app may also calculate and provide a proposed amount for payment for the shipping service. The proposed payment amount may be either established by the party paying for the freight, calculated by algorithm, and/or be negotiated between the freight carrier operator or driver and the party paying the cost of freight.

Further, the app may be configured to assign and communicate an expiration on offers and bids based upon the input of all parties to the transaction. This constraint may be necessary since, for example, trucks often will be physically moving in the direction of the proposed shipping location and may travel past the shipping location before an agreement is reached with that freight carrier.

After all parties agree to the terms, a contract may be awarded to the freight carrier, or trucker, with at least the combination of cost and timeliness of delivery judged most acceptable by the shipper and/or receiver. For example, the party paying the shipping cost might indicate in the app the upper limit of what they will pay.

After all three parties have agreed to the arrangement via the app, the driver of the truck, guided by the mapping program used by the app and by all parties, makes a first deviation (at 100) from its previously intended route 80, as illustrated in FIG. 5, to pick-up the shipment at the shipping location 88 and makes a second deviation (at 102) to deliver, or drop-off, the shipment to the receiving location 92. All parties may have access to tracking of location of the freight carrier and may be provided with an estimated time of arrival (ETA) both for pickup and delivery.

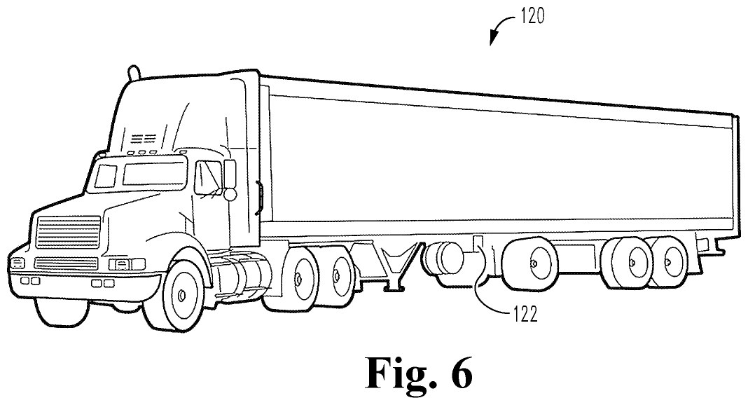

Shown in FIG. 6 is a perspective view of a freight carrier 120 having a designated container 122 for supporting a shipment. When the system has been widely adopted between major markets with sufficient demand, established rendezvous points will be created with numbered holding bins and electronic keys, the combinations for which will be created by the app. Such established locations might have equipment for handling heavy items.

There are many benefits of the system and method of the present disclosure.

Speed of delivery may be expedited, such as within one-day. Items will reach their destination in the time it takes the freight carrier, or truck, to arrive at the shipping location, plus the travel time to the receiving location, plus the travel time from the receiving location to the final destination.

For example, a shipment located in Merrillville, Indiana is needed in Columbus, Ohio. Because a participating freight carrier, or trucker, has input into the app a predetermined route, the shipper, using the app, identifies the participating truck as being twenty minutes north of a truck stop along 165 near Merrillville, enroute from Chicago to Roanoke, Virginia. Twenty minutes is enough time for the item to be taken from a nearby warehouse to the truck stop along the interstate.

The app calculates that the item would, including allowance for fuel, bathroom, and other stops, reach its destination within the window of time specified by the receiver. Therefore, the shipper invites the trucker, via the app, to accept the item for transport in return for payment.

Through the app, the truck agrees to transport the item, detours to the truck stop to retrieve the item, then drives four hours to western Columbus (which is enroute to its ultimate destination) to another truck stop along the interstate, where a representative for the receiver accepts the shipment and drives fifteen minutes to the item's destination (the factory with the broken machine.)

Hence, from the moment of mutual agreement to make the shipment to arrival at its destination is a mere four hours, thirty-five minutes. (20 mins plus 4 hours plus 15 minutes.)

The marginal cost of transporting the item by use of the system approaches zero. In the above example, the trucking company will have invested about twenty minutes time (the detours to, and the item transfers at, the two truck stops) and perhaps $5 worth of fuel.

The 1 lightweight, aluminum, under-carriage container (which usually will be always attached to the truck, even when it contains no load) adds little to fuel expense. Furthermore, the under-carriage container will incidentally serve the function of a wind deflector that reduces drag, a cost-saving feature. So, the container may decrease fuel costs.

By way of contrast, the hire (for example) of an Uber® to transport the item would cost over $500. Transport by airplane, if one where even available, would cost even more. The present system would provide a much less expensive alternative.

Failure to perform the agreed-upon schedule (and/or windows of acceptable rendezvous times) by any party will invoke mutually agreed upon penalties sufficient to incentivize compliance.

In the case that the truck is a semi-tractor and trailer, the truck's primary load will remain securely behind locked doors, so there is no risk to the truck's primary cargo. The item will be transported in a locked container with flexible and quickly applied means of securing the item, the electronic key to said container will be available only to the receiver, via the app.

The system can be rolled out and perfected on limited routes and with selected shippers/receivers/truckers and then be expanded over time, world-wide.

Ease, simplicity, and predictability: The app calculates the costs and times, keeps all parties updated on the progress of the delivery, generates the billing for services, facilitates electronic payment, and produces a bill of lading which, when added to the truck's primary load lading, provides verification in the event of a police traffic and/or weight limit inspection.

Utilization of under-used trucking capacity: By one estimate, 75% of trucks have loads under their allowable maximums; so, they can legally add weight to their loads. Truckers who regularly carry relatively bulky, lighter loads are most likely to participate in the system.

When trucking becomes routinely driverless, said rendezvous points may be either manned or fully automated to load and unload the item into and out of the truck without human intervention.

1. A method of providing expedited shipping, comprising:
receiving a request for a shipment to be delivered to a receiving location; locating the shipment at a shipping location;
providing a list of participating freight carrier operators operating freight carriers along a plurality of different predetermined freight delivery routes;
identifying a qualifying route from the plurality of different predetermined freight delivery routes using an app running on a smart device, wherein the qualifying route passes within a predetermined proximity of each of the shipping location and the receiving location;
confirming the qualifying route and assigning a freight carrier using criteria applied using the app; and
deviating from the qualifying route, by the freight carrier assigned to the qualifying route, to pickup the shipment at the shipping location and deliver the shipment to the receiving location;
wherein the shipment is transported in a separate designated container disposed on the outside of the existing freight container of the freight carrier assigned to the qualifying route.

2. The method of claim 1, further including:
inputting the plurality of different predetermined freight delivery routes by each of the plurality of participating freight carrier operators using the app.

3. The method of claim 1, wherein confirming the qualifying route using criteria of at least one of a shipper, a receiver, and a freight carrier operator further includes:
confirming the qualifying route complies with predetermined cost restraints.

4. The method of claim 1, further including:
inputting a plurality of different potential receiving locations by a receiver using the app.

5. The method of claim 1, further including:
inputting a plurality of different potential shipping locations by a shipper using the app.

6. The method of claim 1, wherein confirming the qualifying route using criteria of at least one of a shipper, a receiver, and a freight carrier operator further includes:
confirming the qualifying route complies with predetermined cost restraints.

7. The method of claim 1, wherein confirming the qualifying route using criteria of at least one of a shipper, a receiver, and a freight carrier operator further includes:
confirming the shipment complies with at least one of size, weight, and composition restraints.

8. The method of claim 1, wherein the designated container is secured in a closed state using an electronic key.

9. The method of claim 1, further including:
providing a shipping cost to at least a freight carrier operator, a receiver, and a shipper.

10. A system for providing expedited shipping, comprising:
an infrastructure for an app, including a web app or a mobile app, installed on a smart device communicating with a backend server and a database;
wherein the app receives a request for a shipment to be delivered to a receiving location;
wherein the app locates the shipment at a shipping location;
wherein the app provides a list of participating freight carrier operators operating freight carriers along a plurality of different predetermined freight delivery routes;
wherein the app identifies a qualifying route from the plurality of different predetermined freight delivery routes, wherein the qualifying route passes within a predetermined proximity of each of the shipping location and the receiving location;
wherein the app confirms the qualifying route and assigns a freight carrier based on predetermined criteria; and
wherein the freight carrier assigned to the qualifying route deviates from the qualifying route to pickup the shipment at the shipping location and deliver the shipment to the receiving location;
wherein the shipment is transported in a designated container separate from and disposed on the existing freight container of the freight carrier assigned to the qualifying route.

11. The system of claim 10, wherein the app is configured to receive input of a plurality of different predetermined freight delivery routes by each of the participating freight carrier operators.

12. The system of claim 10, wherein the app is configured to confirm the qualifying route using criteria of at least one of a shipper, a receiver, and a freight carrier operator.

13. The system of claim 10, wherein the app is configured to confirm that the qualifying route complies with predetermined cost restraints.

14. The system of claim 10, wherein the app is configured to receive input of a plurality of different potential receiving locations by a receiver.

15. The system of claim 10, wherein the app is configured to receive input of a plurality of different potential shipping locations by a shipper.

16. The system of claim 10, wherein the app is configured to provide a shipping cost to at least a freight carrier operator, a receiver, and a shipper.

17. The system of claim 10, wherein the app is configured to confirm the qualifying shipment complies with at least one of size, weight, and composition.

18. A non-transitory computer-readable medium storing instructions that, when executed by a computer, cause it to perform the following method:
receiving a request for a shipment to be delivered to a receiving location;
locating the shipment at a shipping location;
providing a list of participating freight carrier operators operating freight carriers along a plurality of different predetermined freight delivery routes;
identifying a qualifying route from the plurality of different predetermined freight delivery routes using an app running on a smart device, wherein the qualifying route passes within a predetermined proximity of each of the shipping location and the receiving location;
confirming the qualifying route and assigning a freight carrier using criteria applied using the app; and
deviating from the qualifying route, by the freight carrier assigned to the qualifying route, to pickup the shipment at the shipping location and deliver the shipment to the receiving location;
wherein the shipment is transported in a designated container supported below the existing freight container of the freight carrier assigned to the qualifying route.
